(19) United States
(12) Patent Application Publication
(10) Pub. No.: US 2009/0035015 A1
(43) Pub. Date: Feb. 5, 2009

(54) IMAGE FORMING APPARATUS

(75) Inventor: Hiroaki Ohashi, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/183,108

(22) Filed: Jul. 31, 2008

(30) Foreign Application Priority Data
Jul. 31, 2007 (JP) 2007-198805

(51) Int. Cl. G03G 15/08

(52) U.S. Cl. 399/120

(57) ABSTRACT

The image forming apparatus (10) includes the apparatus main body (11), the plurality of photosensitive drums (121) arranged within the apparatus main body (11) in such a manner as to be aligned in a row in a horizontal direction, the plurality of developing devices (122) arranged within the apparatus main body (10) to be associated with the photosensitive drums (121) and supplying toners to the corresponding photosensitive drums (121), and the plurality of toner containers (20) detachably mounted within the apparatus main body (11) in such a manner as to be aligned in a row along the alignment direction of the photosensitive drums (121) while being associated with the developing devices (122). In this image forming apparatus (10), the alignment pitch of the toner containers (20) is set to be greater than the alignment pitch of the photosensitive drums (121).

### BACKGROUND OF THE INVENTION

1. Field of the Invention

The present invention relates to a tandem-type image forming apparatus capable of color printing, which has a plurality of image carrying members aligned in a row.

2. Description of the Related Art

Heretofore, there has been known an image forming apparatus designed to be capable of color printing (see, for example, JP 2002-148892A). This image forming apparatus is referred to as a tandem type which includes an apparatus main body having a box shape in which a plurality of photosensitive drums aligned in a row, a plurality of developing devices each adapted to supply toner onto an outer peripheral surface of the corresponding photosensitive drum, and a plurality of toner cartridges arranged above the developing devices and each adapted to replenish toner to the associated developing device, are provided.

Typically, toner for use in the tandem-type image forming apparatus includes four types, i.e., magenta toner of magenta color, cyan toner of cyan color, yellow toner of yellow color and black toner of black color. In conformity to the respective four types of toners, each of the photosensitive drum, the developing device and the toner cartridge is employed in the number of four.

The four types of toners are sequentially supplied from the developing device to corresponding electrostatic latent images formed on the outer peripheral surfaces of the photosensitive drums by means of irradiation with light from an exposure unit, so that four toner images of the respective colors are developed on the respective outer peripheral surfaces of the photosensitive drums.

In an internal space of the apparatus main body, a transfer belt is disposed in contact relation with the outer peripheral surfaces of the photosensitive drums. This transfer belt is moved to allow the toner images, developed on the outer peripheral surfaces of the photosensitive drums, to be sequentially applied onto an outer surface of the transfer belt in a superimposed manner, so that a color image is formed on the outer surface of the transfer belt. This color image is transferred onto a sheet which is supplied separately. The sheet having the transferred color image thereon is subjected to a fixing process, and then ejected to an outside of the apparatus main body.

In the tandem-type image forming apparatus of the above structure, an alignment pitch of the toner cartridges is set to be equal to an alignment pitch of the photosensitive drums (i.e., an alignment pitch of the developing devices).

When it is attempted to increase a capacity (i.e., internal volume) of each of the toner cartridges under the condition that the alignment pitch of the toner cartridges is set to be equal to that of the photosensitive drums, the only way is to increase the toner cartridge capacity in a horizontal direction orthogonal to an alignment direction of the toner cartridges. If the toner cartridge capacity is increased in the horizontal direction, the capacity increment is unlikely to be accepted by the original size (i.e., original internal volume) of the apparatus main body, to cause a problem that the internal volume of the apparatus main body itself has to be increased against a need for downsizing of the apparatus main body.

### SUMMARY OF THE INVENTION

In view of the above conventional problem, it is an object of the present invention to provide an image forming apparatus having toner replenishing containers each having an increased capacity without opposing the need for downsizing of an apparatus main body of the image forming apparatus.

In order to achieve the above object, the present invention provides an image forming apparatus which includes an apparatus main body, a plurality of image carrying members arranged within the apparatus main body in such a manner as to be aligned in a row in a horizontal direction, a plurality of developing devices arranged within the apparatus main body to be associated with the image carrying members, and supplying toners to the corresponding image carrying members, and a plurality of toner replenishing containers detachably arranged within the apparatus main body in such a manner as to be aligned in a row along the alignment direction of the image carrying members while being associated with the developing devices. An alignment pitch of the toner replenishing containers is set to be greater than an alignment pitch of the image carrying members.

These and other objects, features and advantages of the present invention will become more apparent upon reading of the following detailed description along with the accompanied drawings.

### BRIEF DESCRIPTION OF THE DRAWINGS

FIG. 1 is an explanatory front sectional view showing an internal structure of an image forming apparatus according to one embodiment of the present invention.

FIG. 2 is an external perspective view of the image forming apparatus in FIG. 1 with a portion of the internal structure revealed.

FIG. 3 is an explanatory perspective view showing a layout structure of toner containers in an image forming section of the image forming apparatus, together with other key components such as intermediate hoppers.

FIG. 4 is an explanatory front view showing the layout structure of the toner containers and the intermediate hoppers.

FIG. 5 is an explanatory top plan view showing the layout structure of the toner containers and the intermediate hoppers.

### DETAILED DESCRIPTION OF THE PREFERRED EMBODIMENTS

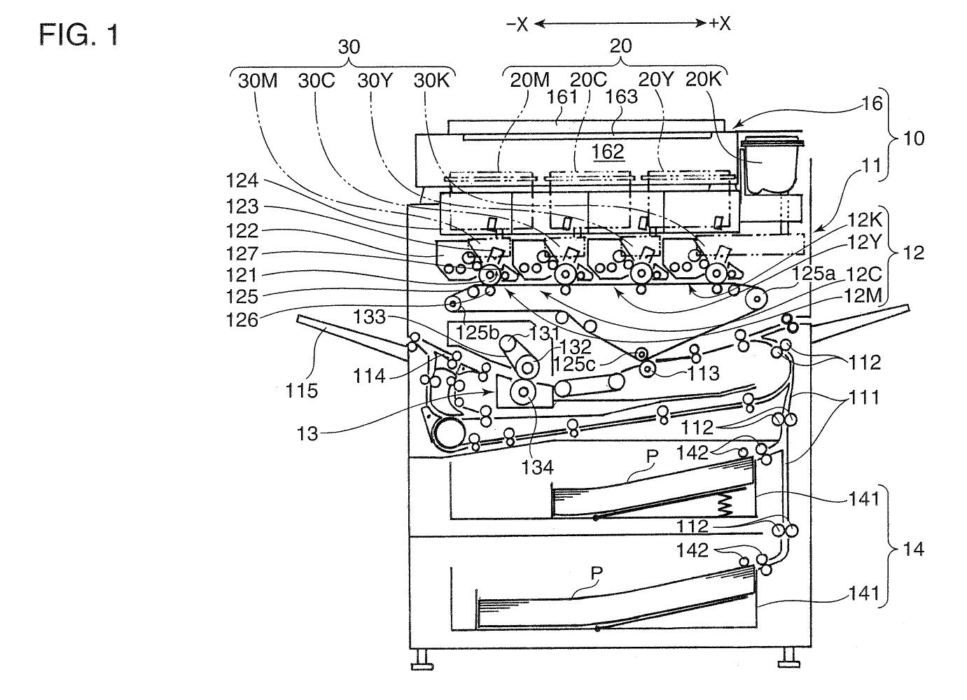

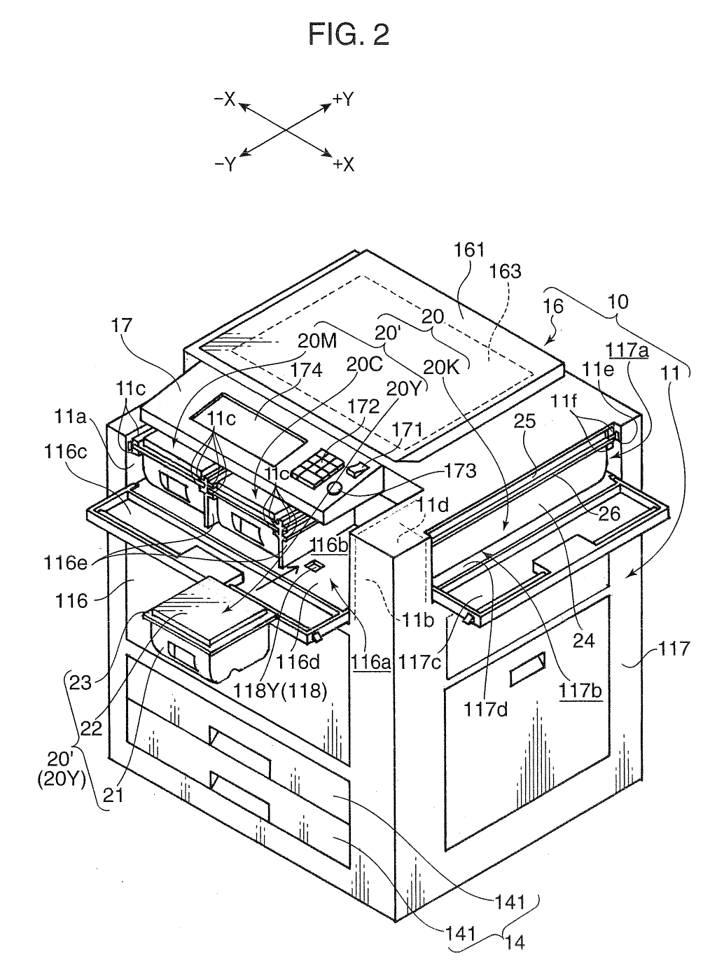

With reference to the accompanying drawings, the present invention will now be specifically described. First of all, an image forming apparatus according to one embodiment of the present invention will be described based on FIGS. 1 and 2. FIG. 1 is an explanatory front sectional view showing an internal structure of the image forming apparatus, and FIG. 2 is an external perspective view of the image forming apparatus. In FIGS. 1 and 2, the X-X direction and the Y-Y direction will hereinafter be referred to respectively as “rightward-leftward direction (or widthwise direction)” and “frontward-rearward direction (or depthwise direction)”. In particular, the −X direction, the +X direction, the −Y direction and the +Y direction will hereinafter be referred to respectively as “leftward (or left)”, “rightward (or right)”, “frontward (or front)” and “rearward (or rear)”.

As shown in FIG. 1, the image forming apparatus 10 is designed to be used as a color copy machine. As a fundamental structure, the image forming apparatus 10 includes an apparatus main body 11 having a box-like shape, and an image reading section 16 provided on the top of the apparatus main body 11 and adapted to read a document image.

The apparatus main body 11 is internally provided with an image forming section 12 for forming an image based on document image data read by the image reading section 16, a fixing section 13 for subjecting to a fixing process the image formed by the image forming section 12 and transferred on a sheet P, and a sheet storage section 14 for storing therein the transfer sheet P.

The image reading section 16 includes a document presser 161 attached to the top surface of the apparatus main body 11 in an openable/closeable manner, and an optical unit 162 disposed in the top of the apparatus main body 11 in opposed relation to the document presser 161 through a contact glass 163. The contact glass 163 is formed in a flat shape having a size slightly smaller than that of document presser 161, so as to allow a document surface of a document placed thereon to be read. The document presser 161 is swingable in opposite directions about a given axis on one edge of the top of the apparatus main body 11 for opening and closing.

A manual operation panel 17 (see FIG. 2) is provided at an appropriate position in the image reading section 16 to allow an operator to manually input conditions of various operations, such as document reading and copying. As shown in FIG. 2, the manual operation panel 17 is provided with a power on/off switch 171, a numerical keypad 172, a start button 173, an LCD (Liquid Crystal Display) 174, and a mode select key (not shown).

Although not illustrated, the optical unit 162 includes, for example, a light source, a plurality of mirrors, a lens unit and a CCD (Charge Coupled Device). Light from the light source is reflected by the document surface, and the reflected light is input into the CCD through the mirrors and the lens unit, as document image data. The document image data input into the CCD in the form of an analog value is converted into a digital signal, and stored on a given storage device.

The image forming section 12 is designed to form a toner image on a sheet P fed from the sheet storage section 14. In this embodiment, the image forming section 12 includes a magenta unit 12M, a cyan unit 12C, a yellow unit 12Y and a black unit 12K, which are sequentially arranged in a direction from an upstream side (left side of the drawing sheet of FIG. 1) toward an downstream side in this order.

Each of the units 12M, 12C, 12Y, 12K is provided with a photosensitive drum 121 (serving as an image carrying member) and a developing device 122. The photosensitive drum 121 is adapted to be supplied with toner from the corresponding developing device 122 while being rotated in a counterclockwise (in FIG. 1) direction. Toner containers 20 (each serving as a toner replenishing container) associated with the developing devices 122 are arranged close to a front end (upper side of the drawing sheet of FIG. 1) and close to a right side (in FIG. 1) of the apparatus main body 11. Each of the toner containers 20 is adapted to replenish toner to the corresponding developing devices 122.

In this embodiment, three toner containers 20 (i.e., a magenta-toner container 20M, a cyan-toner container 20C and a yellow-toner container 20Y) adapted to replenish magenta toner, cyan toner and yellow toner, respectively, to the corresponding one of the three developing devices 122 (i.e., a magenta developing device 122M, a cyan developing device 122C and a yellow developing device 122Y) of the magenta, cyan and yellow units 12M, 12C, 12Y, are detachably mounted at positions close to an upper corner defined between the front side and the top side of the apparatus main body 11 and also forwardly of the optical unit 162. On the other hand, one toner container 20 (i.e., a black-toner container 20K) adapted to replenish black toner to the corresponding developing device 122 (i.e., a black developing device 122K) of the black unit 12K is detachably mounted at a position close to the top side of the apparatus main body 11 and also rightwardly of the optical unit 162.

The image forming section 12 further includes four charging units 123 each disposed immediately above the corresponding one of the four photosensitive drums 121 (i.e., a magenta drum 121M, a cyan drum 121C, a yellow drum 121Y and a black drum 121K), and four exposure units 124 disposed above the charging units 123 and the developing devices 122. Each of the charging units 122 is operable to electrostatically charge an outer peripheral surface of the corresponding one of the photosensitive drums 121 in a uniform manner, and then each of the exposure units 124 is operable, based on image data input in the image reading section 16, to emit a laser beam corresponding to the respective color, onto the charged outer peripheral surface of the corresponding photosensitive drums 121. Through the above operations, an electrostatic latent image is formed on the outer peripheral surface of each of the magenta, cyan, yellow and black drums 121M, 121C, 121Y, 121K.

Then, each of the developing devices 122 (the magenta developing device 122M, the cyan developing device 122C, the yellow developing device 122Y and the black developing device 122K) is operable to supply a respective color toner to the electrostatic latent image on the outer peripheral surface of the corresponding photosensitive drums 121 (the magenta drum 121M, the cyan drum 121C, the yellow drum 121Y and the black drum 121K), so that a toner image is developed on the outer peripheral surface of each of the photosensitive drums 121.

A transfer belt 125 is provided below the photosensitive drums 121 in such a manner that it is wound around between a drive roller 125a, a driven roller 125b, a secondary-transfer counter roller 125c and other required rollers in a tensioned manner, and is disposed to be in contact with the outer peripheral surfaces of the photosensitive drums 121. The transfer belt 125 is moved between the drive roller 125a and the driven roller 125b in synchronization with rotation of the photosensitive drums 121 while being pressed against the outer peripheral surfaces of the photosensitive drums 121 by four primary transfer rollers 126 provided in opposed relation to the photosensitive drums 121.

In conjunction with the movement of the transfer belt 125, a magenta toner image is transferred from the magenta drum 121M of the magenta unit 12M onto an outer surface of the transfer belt 125. Subsequently, a cyan toner image, a yellow toner image and a black toner image are sequentially transferred, respectively, from the cyan drum 121C of the cyan unit 12C, the yellow drum 121Y of the yellow unit 12Y, and the black drum 121K of the black unit 12K, onto the same position of the outer surface of the transfer belt 125 in a superimposed manner. In this manner, a color toner image is formed on the outer surface of the transfer belt 125. The color toner image formed on the outer surface of the transfer belt 125 is transferred onto a sheet P transported from the sheet storage section 14.

A cleaning unit 127 is provided at a position rightwardly (in FIG. 1) of each of the photosensitive drums 121 to remove residual toner on the outer peripheral surface of the photosensitive drum 121. Then, the photosensitive drums 121 having the outer peripheral surface subjected to the cleaning process by the cleaning unit 127 are then charged by the corresponding charging units 123 to carry out a new charging process.

Waste toner removed from the outer peripheral surface of the photosensitive drum 121 by the cleaning unit 127 is collected to a toner collection bottle (not shown) through a given path.

A sheet transport passage 111 is formed to extend from a right side (in FIG. 1) of the sheet storage section 14 to a lower region of the image forming section 12. The transport roller pairs 112 are provided in the sheet transport passage 111 at appropriate positions. The transport roller pairs 112 are adapted to be driven so as to allow a sheet fed from the sheet storage section 14 to be transported to a position below the transfer belt 125. Further, a secondary transfer roller 113 is provided in the sheet transport passage 111 at a position opposed to the secondary transfer roller 125c, in such a manner as to be in contact with the outer surface of the transfer belt 125. Thus, a sheet P being transported through the sheet transport passage 111 is nipped and pressed between the transfer belt 125 and the secondary transfer roller 113, so that the color toner image on the transfer belt 125 is transferred onto the sheet P.

The fixing section 13 is designed to subject the toner image, transferred on the sheet P by the image forming section 12, to the fixing process. The fixing section 13 includes a heating roller 131 internally having an electric heating element serving as a heating source, such as a halogen lamp, and a fixing roller 132 disposed in spaced-apart relation to the heating roller 131, a fixing belt 133 wound around between the fixing roller 132 and the heating roller 131 in a tensioned manner, and a pressing roller 134 disposed in opposed relation to the fixing roller 132 through the fixing belt 133.

The sheet P with a color image subjected to the fixing process is ejected to a catch tray 115 provided to a left wall (in FIG. 1) of the apparatus main body 11, through a sheet ejection passage 114 extending from an upper region of the fixing section 13.

The sheet storage section 14 includes a sheet tray 141 detachably mounted at a position below the image forming section 12 and the fixing section 13 for storing therein a stack of sheets P. In the embodiment illustrated in FIGS. 1 and 2, the sheet tray 141 is provided in the number of two in a tiered manner. Alternatively, the sheet tray 141 may be provided in the number of three or more in a tiered manner, or may be provided in the number of one.

The sheet storage section 14 is provided with a pickup roller 142 which is adapted to be driven so as to allow the sheets P to be fed from the sheet tray 141 one by one. The sheet P fed from the sheet tray 141 is transported to a nip defined between the secondary transfer roller 113 and the transfer belt 125 of the image forming section 12, through the sheet transport passage 111, and a color toner image formed on the outer surface of the transfer belt 125 is then transferred onto the sheet P. After completion of the secondary transfer process, the sheet P is transported in the aforementioned manner.

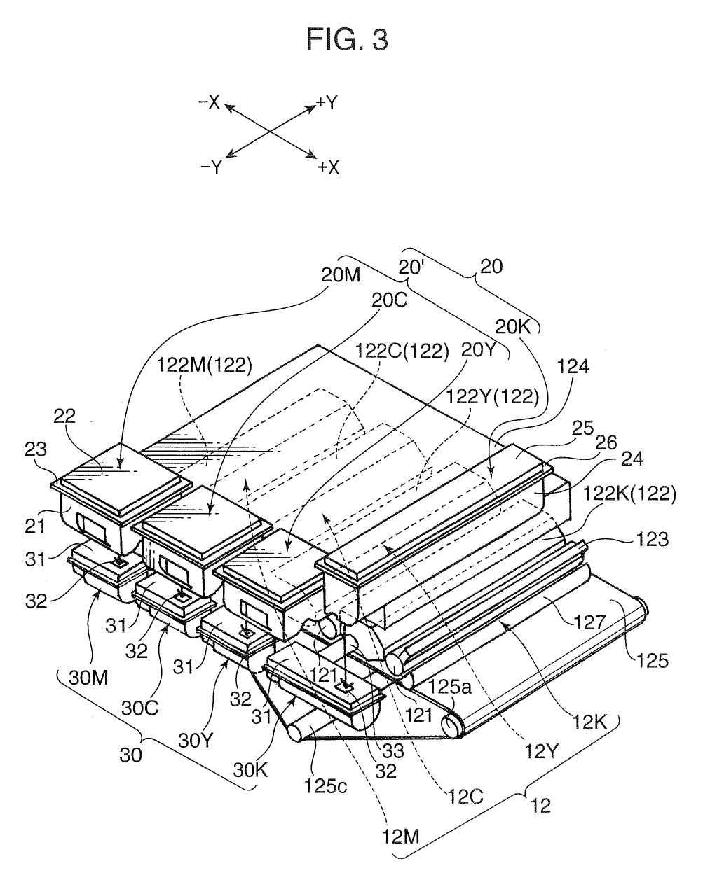

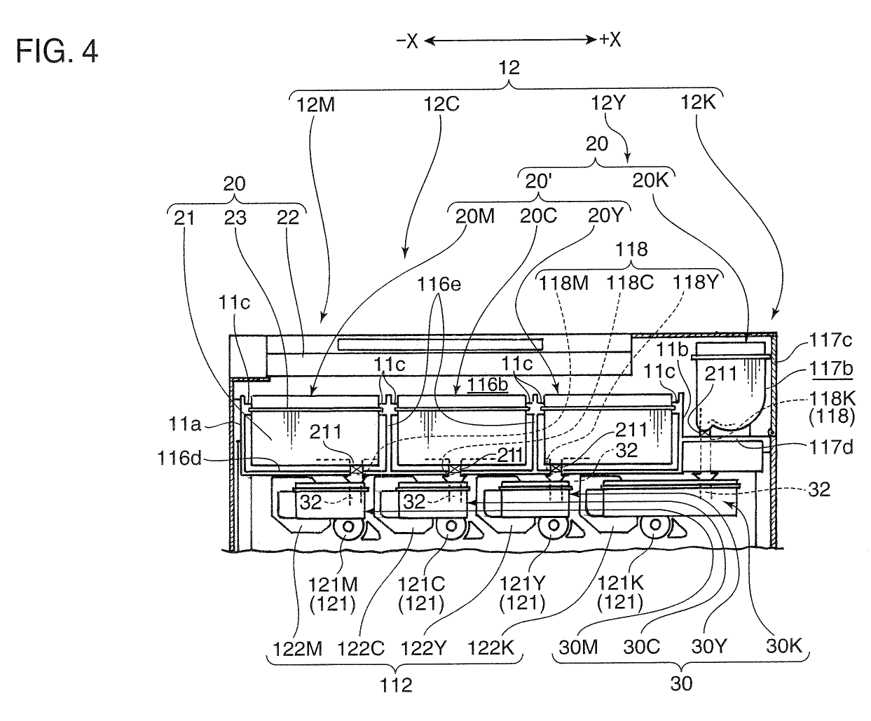

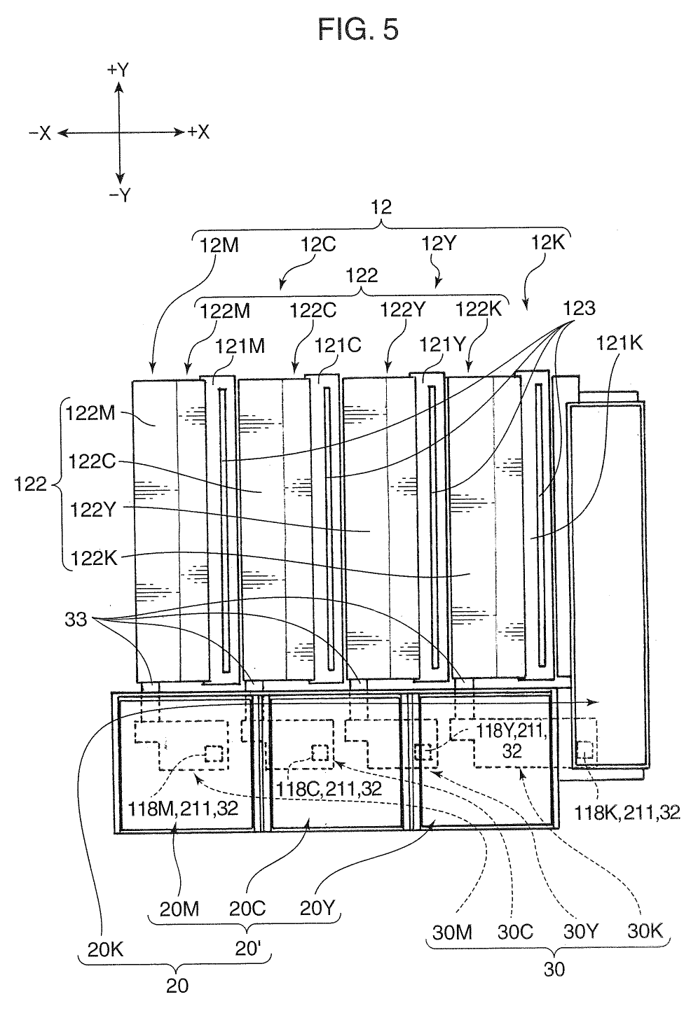

The layout structure of the toner containers 20 will be described below, based on FIGS. 3 to 5 and with reference to FIGS. 1 and 2 as needed. FIG. 3 is an explanatory perspective view showing the layout structure of the toner containers 20 in the image forming section 12, together with other components such as intermediate hoppers 30. FIG. 4 is a front view showing the layout structure of the toner containers 20 and the intermediate hoppers 30, and FIG. 5 is a top plan view of the layout structure. In FIGS. 3 to 5, the X-X direction and the Y-Y direction will hereinafter be referred to respectively as “rightward-leftward direction (or widthwise direction)” and “frontward-rearward direction (or depthwise direction)”, and, in particular, the −X direction, the +X direction, the −Y direction and the +Y direction will hereinafter be referred to respectively as “leftward (or left)”, “rightward (or right)”, “frontward (or front)” and “rearward (or rear)”, in the same manner as that in FIGS. 1 and 2.

As shown in FIGS. 1 and 2, the magenta-toner, cyan-toner and yellow-toner containers 20M, 20C, 20Y [each of the three toner containers will hereinafter be referred to as “color-toner container (color-toner replenishing container) 20′”] in the four toner containers 20 are detachably mounted in an upper region of the front side of the apparatus main body 11. On the other hand, the black-toner container 20K is detachably mounted in an upper region of the right side of the apparatus main body 11.

The color-toner container 20′ is arranged in such a manner as to effectively utilize a usable widthwise (i.e., rightward-leftward) dimension in the internal space of the apparatus main body 11. Specifically, three color-toner containers 20′ are mounted at an even pitch over a distance range from a left end to a right end of the image forming section 12. That is, an alignment pitch of the color-toner containers 20′ is set to be about 4/3 times an alignment pitch of the units 12M, 12C, 12Y, 12K of the image forming section 12 (i.e., an alignment pitch of the photosensitive drums 121).

Thus, as compared with the conventional image forming apparatus where the color-toner containers 20′ are aligned in a row at a pitch equal to that of the photosensitive drums 121, the capacity (i.e., internal volume) of each of the color-toner containers 20′ is increased by about 33%.

The apparatus main body 11 has a front plate 116 which is cut out downwardly from an upper edge thereof to form a front opening 116a (see FIG. 2) extending in the X-X direction. The magenta-toner, cyan-toner and yellow-toner containers 20M, 20C, 20Y are inserted into a mounting space 116b through the front opening 116a.

The front opening 116a is provided with a front door 116c having a base end supported by a support shaft (not shown) extending in the rightward-leftward direction, in a swingable manner about the support shaft. Thus, an operator can swingably move the front door 116c about the support shaft in opposite directions to allow a posture of the front door 116c to be changed between a closed posture for closing the mounting space 116b and an open posture for opening the mounting space 116b.

A bottom plate 116d, a left wall 11a and a right wall 11b are provided in the apparatus main body 11 to define the mounting space 116b, and two right and left partition plates 116e are mounted on the bottom plate 116d to divide the mounting space 116b equally into three sub-spaces. The magenta-toner container 20M is mounted in the left sub-space defined between the left wall 11a and the left partition plate 116e. The cyan-toner container 20C is mounted in the middle sub-space defined between the two partition plates 116e, and the yellow-toner container 20Y is mounted in the right sub-space defined between the right partition plate 116e and the right wall 11b.

In this embodiment, each of the color-toner containers 20′ has a square shape in top plan view, as shown in FIGS. 2, 3 and 5. Each of the color-toner containers 20′ includes a slightly flat, box-shaped container body 21, and a lid member 22 for closing an upper opening of the container body 21. The container body 21 has an annular-shaped, body-side flange provided along an entire upper edge thereof to protrude outwardly. The lid member 22 has an annular-shaped, lid-side flange provided along an entire lower edge thereof to protrude outwardly. The flange of the lid member 22 is fixedly joined to the flange of the container body 21 through a glue or adhesive so as to allow the upper opening of the container body 21 to be closed by the lid member 22, and the two flanges are formed as an annular-shaped flange 23 of the color-toner container 20′. In this state, the color-toner container 20′ has already been filled with toner.

Each of opposed surfaces of the left wall 11a and the left partition plate 116e, opposed surfaces of the two partition plates 116e, and opposed surfaces of the right partition plate 116e and the right wall 11b, is provided with a guide rail pair 11c extending in the frontward-rearward direction at a position corresponding to the flange 23 of the color-toner container 20′. A gap between two guide rails of the guide rail pair 11c is set at a value slightly greater than a thickness dimension of the flange 23. Thus, each of the color-toner containers 20′ is mounted in a corresponding one of the mounting sub-spaces of the mounting space 116b in a positioned state by fittingly inserting right and left portions of the flange 23 into the respective opposed guide rail pairs 11c in the mounting sub-space 116b.

The apparatus main body 11 has a right plate 117 which is cut out downwardly from an upper edge thereof to form a lateral opening 117a (see FIG. 2) extending in the frontward-rearward direction. The black-toner container 20K is detachably mounted in a mounting space 117b through the lateral opening 117a.

The lateral opening 117a is provided with a lateral door 117c having a base end supported by a support shaft (not shown) extending in the frontward-rearward direction, in a swingable manner about the support shaft. Thus, an operator can swingably move the lateral door 117c about the support shaft in opposite directions to allow a posture of the lateral door 117c to be changed between a closed posture for closing the mounting space 117b and an open posture for opening the mounting space 117b. A bottom plate 117d is provided to define the mounting space 117b.

The black-toner container 20K has an elongate rectangular shape extending in the frontward-rearward direction, in top plan view, as shown in FIGS. 2, 3 and 5. The black-toner container 20K includes an elongate parallelepiped-shaped container body 24 extending in the frontward-rearward direction, and a lid member 25 for closing an upper opening of the container body 24. The container body 24 has an annular-shaped body-side flange provided along an entire upper edge thereof to protrude outwardly. The lid member 25 has an annular-shaped lid-side flange provided along an entire lower edge thereof to protrude outwardly. The flange of the lid member 25 is fixedly joined to the flange of the container body 24 through a glue or adhesive so as to allow the upper opening of the container body 24 to be closed by the lid member 25, and the two flanges are formed as an annular-shaped flange 26 of the black-toner container 20K. In this state, the black-toner container 20K has already been filled with black toner. That is, after the container body 24 is filled with toner, the upper opening of the container body 24 is closed by the lid member 25, and the two flanges are fixed to each other through a glue or adhesive.

Each of a front wall 11d and a rear wall 11e of the apparatus main body 11 defining the mounting space 117d is provided with a guide rail pair 11f extending in the rightward-leftward direction at a position corresponding to the flange 26 of the black-toner container 20K. A gap between two guide rails of the guide rail pair 11f is set at a value slightly greater than a thickness dimension of the flange 26. Thus, the black-toner container 20K is mounted in the mounting space 117b in a positioned state by fittingly inserting front and rear portions of the flange 26 into the respective opposed guide rail pairs 1 if in the mounting space 117b.

Each of the magenta, cyan, yellow and black-toner containers 20M, 20C, 20Y, 20K after mounted in the mounting spaces 116b, 117b is adapted to allow a driving force of a driving motor (not shown) to be transmitted to an agitating/feeding member disposed therein. The agitating/feeding member is operable, when it is driven by the driving motor as needed, to circulate and feed toner in the container toward an after-mentioned shutter member 211 in its open state, while agitating the toner. Thus, the toner stored in the toner container 20 is replenished to the corresponding developing device 122 through the shutter member in the open state and the corresponding mentioned intermediate hopper 30.

Four intermediate hoppers 30 are disposed immediately below the bottom plate 116d and between the toner containers 20 and the developing devices 122, and each of the intermediate hoppers is designed to relay the toner from each of the toner containers 20 to an associated one of the developing devices 122. As shown in FIG. 4, the four intermediate hoppers 30 includes a magenta-toner intermediate hopper 30M associated with the magenta developing device 122M, a cyan-toner intermediate hopper 30C associated with the cyan developing device 122C, a yellow-toner intermediate hopper 30Y associated with the yellow developing device 122Y, and a black-toner intermediate hopper 30K associated with the black developing device 122K.

As shown in FIG. 4, an alignment pitch of the intermediate hoppers 30M, 30C, 30Y, 30K is set to be equal to an alignment pitch of the developing devices 122M, 122C, 122Y, 122K. Further, each of the magenta, cyan and yellow intermediate hoppers 30M, 30C, 30Y is configured to have the same size.

On the other hand, the black-toner intermediate hopper 30K is, according to the size of the black-toner container 20K mounted in the upper region of the right side of the apparatus main body 11, configured to be longer in the rightward-leftward direction than each of the intermediate hoppers 30M, 30C, 30Y.

Each of the intermediate hoppers 30 has a top plate 31 formed with a toner-receiving hole 32 on a right portion thereof. The bottom plate 116d of the mounting space 116b accommodating therein the color-toner containers 20′ is formed with three communication holes 118 at positions corresponding to the three toner-receiving holes 32. The three communication holes 118 includes a magenta-toner communication hole 118M corresponding to the toner-receiving hole 32 of the magenta-toner intermediate hopper 30M, a cyan-toner communication hole 118C corresponding to the toner-receiving hole 32 of the cyan-toner intermediate hopper 30C, and a yellow-toner communication hole 118Y corresponding to the toner-receiving hole 32 of the yellow-toner intermediate hopper 30Y.

Thus, as shown in FIG. 4, the magenta-toner communication hole 118M is formed at a rightward position (i.e., a position close to the left partition plate 116e) in a region of the bottom plate 116d between the left wall 11a and the left partition plate 116e. The cyan-toner communication hole 118C is formed at an approximately central position in a region of the bottom plate 116d between the two partition plates 116e, and the yellow-toner communication hole 118Y is formed at a leftward position (i.e., a position close to the right partition plate 116e) in a region of the bottom plate 116d between the right partition plate 116e and the right wall 11b.

The bottom plate 117d is formed with a communication hole 118 (black-toner communication hole 118K) at a position corresponding to a toner-receiving hole 32 of the black-toner intermediate hopper 30K. The black-toner communication hole 118K is formed at a leftward and frontward position (i.e., a position close to the right wall 11b) in the bottom plate 117d defining the mounting space 117b for the black-toner container 20K.

Each of the magenta-toner, cyan-toner, yellow-toner and black-toner containers 20M, 20C, 20Y, 20K is provided with a shutter member 211 in a bottom thereof at a position corresponding to the magenta-toner, cyan-toner, yellow-toner and black-toner communication holes 118M, 118C, 118Y, 118K. Each of the shutter members 211 is placed in its closed position before each of the magenta-toner, cyan-toner and yellow-toner containers 20M, 20C, 20Y and the black-toner container 20K is mounted in the mounting spaces 116b, 117b (see FIG. 2), and placed in its open position when each of the toner containers 20 is mounted in a corresponding one of the mounting spaces 116b, 117b, so as to allow an internal space of the toner container 20 to be communicated with an internal space of the corresponding intermediate hopper 30.

As shown in FIGS. 3 and 5, each of the developing devices 122 has a left end partly formed with a tubular-shaped extension portion 33 extending up to a left end of the corresponding one of the intermediate hoppers 30. The extension portion 33 of each of the developing devices 122 is internally provided with a screw feeder (not shown) extending in the frontward-rearward direction. Each of the screw feeders of the developing devices 122M, 122C, 122Y, 122K is adapted to be drivenly rotated about an axis thereof so as to allow the toner in the corresponding magenta-toner, cyan-toner, yellow-toner and black-toner intermediate hoppers 20M, 30C, 30Y, 30K to be replenished toward the developing device 122M, 122C, 122Y, 122K.

As described above in detail, the image forming apparatus 10 according to this embodiment of the present invention includes the apparatus main body 11, the plurality of photosensitive drums 121 arranged within the apparatus main body 11 in such a manner as to be aligned in a row in a horizontal direction, the plurality of developing devices 122 arranged within the apparatus main body 10 to be associated with the photosensitive drums 121 and supplying toners to the corresponding photosensitive drums 121, and the plurality of toner containers 20 detachably mounted within the apparatus main body 11 in such a manner as to be aligned in a row along the alignment direction of the photosensitive drums 121 while being associated with the developing devices 122. In this image forming apparatus 10, the alignment pitch of the toner containers 20 is set to be greater than the alignment pitch of the photosensitive drums 121.

As above, the alignment pitch of the toner containers 20 (the magenta-toner, cyan-toner, yellow-toner and black-toner containers 20M, 20C, 20Y, 20K) is set to be greater than the alignment pitch of the photosensitive drums 121 (the magenta, cyan, yellow and black drums 121M, 121C, 121Y, 121K). This setting of the alignment pitch makes it possible to form each of the toner containers 20 into a shape which is extended in the alignment direction (i.e., the rightward-leftward direction) of the photosensitive drums 121. Since the apparatus main body 11 generally has a dead space in the alignment direction which is usable for component layout, the capacity of each of the toner containers 20 can be increased without expanding the current internal volume of the apparatus main body 11.

Since the alignment pitch of the toner containers 20 is set to become different from that of the photosensitive drums 121, the shutter members 211 of the toner containers 20, which are communicated with the developing devices 122 arranged at positions corresponding to the respective photosensitive drums 121, can be set at different positions relative to each other. This makes it possible to prevent the occurrence of an undesirable situation where the color-toner containers 20′ are mounted in the mounting space 116b in a wrong order.

Further, considering that an amount of black toner to be used is greater than that of each of other color toners, the capacity of the black-toner container 20K storing therein a black toner is generally set to be greater than that of each of the color-toner containers 20′ storing therein toners of other colors. Thus, the large-capacity black-toner container 20K is configured in a shape extending in a direction (+Y-−Y direction) orthogonal to the alignment direction (+X-−X direction) of the color-toner containers 20′, and is mounted in the mounting space 117b along the orthogonal direction. This makes it possible to increase the capacities of all the toner containers 20 while taking into account balance of overall layout structure, without expanding the current internal volume of the apparatus main body 11.

The color-toner containers 20′ are arranged within the apparatus main body 11 at positions close to the front side of the apparatus main body 11 and diagonally above the row of the photosensitive drums 121. In many cases, such positions are generally in an unutilized dead space in the conventional apparatus main body 11. Thus, the mounting of the color-toner containers 20′ in the dead space makes it possible to increase the capacity of each of the color-toner containers 20′ without expanding the current internal volume of the apparatus main body 11.

It is understood that the present invention is not limited to the above specific embodiment. For example, the above embodiment may be modified as follows.

(1) While the above embodiment has been described by taking a copy machine as one example of the image forming apparatus 10, the image forming apparatus 10 of the present invention is not limited to the copy machine, but may be a printer for subjecting image data input from an external device, such as a computer, to a printing process, or may be a facsimile machine for outputting an image based on image data transmitted via a communication line.

(2) In the above embodiment, the color-toner containers 20′ including the magenta-toner, cyan-toner and yellow-toner containers 20M, 20C, 20Y are mounted in the upper corner region at the front side of the apparatus main body 11, and the black-toner container 20K is mounted in the upper corner region at the right side of the apparatus main body 11. Alternatively, the black-toner container 20K may be mounted at the front side of the apparatus main body 11 in the same manner as the color-toner containers 20′.

In the above embodiment, the mounting and detaching of the black-toner container 20K relative to the apparatus main body 11 is performed from a lateral side (in the embodiment illustrated in FIG. 2, from a right side) of the apparatus main body 11. Alternatively, the mounting and detaching of the black-toner container 20K relative to the apparatus main body 11 is performed from a front side of the apparatus main body 11 in the same manner as that in the color-toner containers 20′.

(3) While the black-toner container 20K in the above embodiment is disposed in the upper corner region at the right side of the apparatus main body 11, the present invention is not limited to the layout where the black-toner container 20K is arranged in the upper corner region at the right side of the apparatus main body 11, but the black-toner container 20K may be disposed in an upper corner region at a left side of the apparatus main body 11 depending on the situation.

(4) While the image forming apparatus according to the above embodiment is designed such that the intermediate hopper 30 is interposed between the toner container 20 and the associated developing device 122, it is not essential for the present invention to employ the intermediate hopper 30. For example, the image forming apparatus may be designed to directly replenish toner from the toner container 20 to the associated developing device 122 without additionally providing the intermediate hopper 30.

(5) In the above embodiment, the transfer belt 125 is provided below the photosensitive drums 121, and the exposure units 124 are provided above the photosensitive drums 121. Alternatively, this layout may be reversed, i.e., the transfer belt 125 is provided at a position above the photosensitive drums 121, and the exposure units 124 are provided below the photosensitive drums 121.

(6) While the toner employed in the above embodiment includes magenta toner, cyan toner, yellow toner and black toner, the toner for use in the present invention is not limited to the four types, but may be three types or less or may be five types or more. In this case, the image forming apparatus 10 of the present invention includes an apparatus main body, a plural number N of photosensitive drums 121 positioned within the apparatus main body in such a manner as to be aligned in a row in a horizontal direction, a plural number N of developing devices 122 arranged within the apparatus main body to be associated with the N photosensitive drums 121 and supplying toners to the corresponding photosensitive drums 121, and a plural number N of toner containers 20 arranged within the apparatus main body while being associated with the N developing devices 122. In this image forming apparatus 10, preferably, the (N-1) toner containers 20 are aligned in a row in the alignment direction of the photosensitive drums 121, and the remaining toner container 20 (typically, a black-toner container 20K) is configured to be elongated in a direction in which an endmost one of the photosensitive drums 121 extends. Also, the N toner containers 20 are preferably arranged in an L shape in top plan view. It is preferable in this image forming apparatus 10 that N is an integer number of three or more.

The aforementioned image forming apparatus 10 includes the following features.

An image forming apparatus according to a first aspect of the present invention includes an apparatus main body, a plurality of image carrying members arranged within the apparatus main body in such a manner as to be aligned in a row in a horizontal direction, a plurality of developing devices arranged within the apparatus main body to be associated with the image carrying members, and supplying toners to the corresponding image carrying members, and a plurality of toner replenishing containers detachably arranged within the apparatus main body in such a manner as to be aligned in a row along the alignment direction of the image carrying members while being associated with the developing devices. An alignment pitch of the toner replenishing containers is set to be greater than an alignment pitch of the image carrying members.

According to this image forming apparatus of the present invention, the alignment pitch of the toner replenishing containers is set to be greater than the alignment pitch of the image carrying members. Thus, the capacity (i.e., internal volume) of each of the toner replenishing containers can be increased in the alignment direction of the image carrying members and the toner replenishing containers (i.e., the rightward-leftward direction of the apparatus main body) along which the apparatus main body generally has an unutilized space usable for component layout.

Specifically, if the capacity of each of the toner replenishing containers is increased in a direction orthogonal to the alignment direction of the toner replenishing containers, i.e., in the frontward-rearward direction of the apparatus main body, the internal volume of the apparatus main body itself has to be increased in the frontward-rearward direction because the apparatus main body generally has no dead space usable for component layout. This causes a problem of going against the need for downsizing of the image forming apparatus. The image forming apparatus of the present invention can avoid such a problem.

Further, in the image forming apparatus of the present invention, the alignment pitch of the toner replenishing containers is set to become different from the alignment pitch of the image carrying members. Thus, respective toner replenishing holes of the toner replenishing containers, each connected to the corresponding developing device, are arranged at different positions relative to each other. This makes it possible to facilitate adequately performing an operation of mounting the toner replenishing containers relative to the corresponding developing devices.

Preferably, in the image forming apparatus of the present invention, the toner replenishing containers include a black-toner replenishing container for replenishing a black toner, and_color-toner replenishing containers for replenishing color toners, and the black-toner replenishing container is configured in an elongate container shape extending in a direction orthogonal to the alignment direction of the color-toner replenishing containers.

Considering that an amount of black tonier to be used is greater than that of each of the color toners, the capacity of the black-toner replenishing container needs to be set at a value greater than that of each of the color-toner replenishing containers. According to the above feature, the black-toner replenishing container is configured in an elongate container shape extending in a direction (the frontward-rearward direction of the apparatus main body) orthogonal to the alignment direction of the color-toner replenishing containers, so as to allow the capacity of the black-toner replenishing container to be sufficiently ensured. This makes it possible to increase the capacities of all the toner replenishing containers without increasing the internal volume of the apparatus main body.

Preferably, in the above image forming apparatus, the image carrying members are aligned in a row in a generally central region of the apparatus main body and along a horizontal plane while extending in a frontward-rearward direction of the apparatus main body, and the color-toner replenishing containers are arranged at positions close to a front side of the apparatus main body and diagonally above the aligned image carrying members.

In many cases, such positions are generally in an unutilized dead space in the apparatus main body. According to the above feature, the color-toner replenishing containers are mounted in the dead space. This makes it possible to increase the capacity of each of the color-toner replenishing containers without increasing the internal volume of the apparatus main body.

Preferably, in the above image forming apparatus, the alignment direction of the toner replenishing containers is a rightward-leftward direction orthogonal to the frontward-rearward direction of the apparatus main body.

In the above image forming apparatus, the alignment pitch of the color-toner replenishing containers is set to be about 4/3 times the alignment pitch of the image carrying members.

An image forming apparatus according to a second aspect of the present invention includes an apparatus main body, a plural number N of image carrying members arranged within the apparatus main body in such a manner as to be aligned in a row in a horizontal direction, a plural number N of developing devices arranged within the apparatus main body to be associated with the N image carrying members, and supplying toners to the respective corresponding image carrying members, and a plural number N of toner replenishing containers arranged within the apparatus main body to be associated with the N developing devices. The (N-1) toner replenishing containers are aligned in a row along the alignment direction of the image carrying members, and the remaining toner replenishing container is configured to be elongated in a direction in which an endmost one of the image carrying members extends.

According to this image forming apparatus of the present invention, the (N-1) toner replenishing containers are aligned in a row in the alignment direction of the N image carrying members. Since the number of the toner replenishing containers is smaller than that of the image carrying members, a widthwise (i.e., the rightward-leftward direction of the apparatus main body) dimension of each of the (N-1) toner replenishing containers can be increased. This makes it possible to increase the capacity of each of the (N-1) toner replenishing containers. Further, the remaining toner replenishing container is configured to be elongated in a direction in which an endmost one of the image carrying members extends or in a direction orthogonal to the alignment direction of the (N-1) toner replenishing containers (i.e., in the frontward-rearward direction of the apparatus main body). This makes it possible to increase a capacity of each of the N toner replenishing containers without increasing an internal volume of the apparatus main body.

In the above image forming apparatus, the N toner replenishing containers may be arranged in an L shape in top plan view. According to this feature, the increase in the capacity of each of the N toner replenishing containers can be readily achieved while ensuring balanced layout of the N toner replenishing containers.

This application is based on Japanese Patent Application No. 2007-198805 filed in Japan Patent Office on Jul. 31, 2007 the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an apparatus main body;
a plurality of image carrying members arranged within the apparatus main body in such a manner as to be aligned in a row in a horizontal direction;
a plurality of developing devices arranged within the apparatus main body to be associated with the image carrying members, and supplying toners to the corresponding image carrying members;
a plurality of toner replenishing containers detachably arranged within the apparatus main body in such a manner as to be aligned in a row along the alignment direction of the image carrying members while being associated with the developing devices; and
wherein an alignment pitch of the toner replenishing containers is set to be greater than an alignment pitch of the image carrying members.

2. The image forming apparatus as defined in claim 1, wherein the toner replenishing containers include a black-toner replenishing container for replenishing a black toner, and color-toner replenishing containers for replenishing color toners; and
wherein the black-toner replenishing container is configured in an elongate container shape extending in a direction orthogonal to the alignment direction of the color-toner replenishing containers.

3. The image forming apparatus as defined in claim 2, wherein the image carrying members are aligned in a row in a generally central region of the apparatus main body and along a horizontal plane while extending in a frontward-rearward direction of the apparatus main body; and
wherein the color-toner replenishing containers are arranged at positions close to a front side of the apparatus main body and diagonally above the aligned image carrying members.

4. The image forming apparatus as defined in claim 3, wherein the alignment direction of the toner replenishing containers is a rightward-leftward direction orthogonal to the frontward-rearward direction of the apparatus main body.

5. The image forming apparatus as defined in claim 2, wherein the alignment pitch of the color-toner replenishing containers is set to be about 4/3 times the alignment pitch of the image carrying members.

6. An image forming apparatus comprising:
an apparatus main body;
a plural number N of image carrying members arranged within the apparatus main body in such a manner as to be aligned in a row in a horizontal direction;
a plural number N of developing devices arranged within the apparatus main body to be associated with the N image carrying members, and supplying toners to the respective corresponding image carrying members;
a plural number N of toner replenishing containers arranged within the apparatus main body to be associated with the N developing devices; and
wherein the (N-1) toner replenishing containers are aligned in a row along the alignment direction of the image carrying members, and the remaining toner replenishing container is configured to be elongated in a direction in which an endmost one of the image carrying members extends.

7. The image forming apparatus as defined in claim 6, wherein the N toner replenishing containers are arranged in an L shape in top plan view.

8. The image forming apparatus as defined in claim 6, wherein the N image carrying members are aligned in a row in a generally central region of the apparatus main body and along a horizontal plane while extending in a frontward-rearward direction of the apparatus main body; and
wherein the alignment direction of the (N-1) toner replenishing containers is a rightward-leftward direction orthogonal to the frontward-rearward direction of the apparatus main body.

9. The image forming apparatus as defined in claim 6, wherein an alignment pitch of the (N-1) toner replenishing containers is set to be about 4/3 times an alignment pitch of the N image carrying members.
